(19) United States
(12) Patent Application Publication
(10) Pub. No.: US 2026/0249789 A1
(43) Pub. Date: Aug. 27, 2026

(54) MOTORIZED ROOF BIKE RACK

(71) Applicant: Scout Motors Inc., Tysons, VA (US)

(72) Inventor: Daniel Davis, West Bloomfield Township, MI (US)

(21) Appl. No.: 19/063,871

(22) Filed: Feb. 26, 2025

(51) Int. Cl. B60R 9/10

(52) U.S. Cl. CPC B60R 9/10

(57) ABSTRACT

A motorized bicycle rack includes a base rail, a mounting platform coupled to the base rail, a translational actuator operably coupled to the mounting platform, and a rotational actuator operably coupled to the mounting platform. The mounting platform defines a rotational axis and has a securing device to selectively couple a bicycle to the mounting platform. The translational actuator moves the mounting platform between a stored position and a translated position. The rotational actuator rotates the mounting platform between a loading position and the translated position. In the loading position, the mounting platform extends beyond a rear end of the vehicle and the securing device faces a surface on which the vehicle is supported. In the translated position, at least a portion of the mounting platform extends beyond the rear end of the vehicle and the securing device faces away from the surface on which the vehicle is supported

### BACKGROUND

The present disclosure relates to a bicycle rack for a vehicle.

### SUMMARY

Various implementation described herein are related to a motorized bicycle rack.

In some implementations, a motorized bicycle rack is configured to be coupled to a roof of a vehicle. The motorized bicycle rack includes a base rail configured to be rigidly coupled to the roof of the vehicle and a mounting platform coupled to the base rail. The mounting platform defines a rotational axis. The mounting platform has a securing device configured to selectively couple a bicycle to the mounting platform. The motorized bicycle rack further includes a translational actuator operably coupled to the mounting platform. The translational actuator is configured to move the mounting platform along a longitudinal axis of the vehicle. The motorized bicycle rack further includes a rotational actuator operably coupled to the mounting platform. The rotational actuator is configured to rotate the mounting platform relative to the base rail about the rotational axis. The translational actuator is configured to move the mounting platform between a stored position and a translated position. The rotational actuator is configured to rotate the mounting platform between a loading position and the translated position. In the loading position, the mounting platform extends beyond a rear end of the vehicle and the securing device faces a surface on which the vehicle is supported, and in the translated position, at least a portion of the mounting platform extends beyond the rear end of the vehicle and the securing device faces away from the surface on which the vehicle is supported.

In some implementations, a motorized bicycle rack is configured to be coupled to a roof of a vehicle. The motorized bicycle rack includes a base rail configured to be rigidly coupled to the roof of the vehicle and a mounting platform coupled to the base rail. The mounting platform defines a rotational axis. The mounting platform has a securing device configured to selectively couple a bicycle to the mounting platform. The motorized bicycle rack further includes a translational actuator operably coupled to the mounting platform. The translational actuator configured to move the mounting platform along a longitudinal axis of the vehicle. The motorized bicycle rack further includes a rotational actuator operably coupled to the mounting platform. The rotational actuator is configured to rotate the mounting platform relative to the base rail about the rotational axis. The translational actuator is configured to move the mounting platform between a stored position and a translated position. The rotational actuator is configured to rotate the mounting platform between a loading position and the translated position. In the loading position, the rotational axis of the mounting platform is beyond a rear end of the vehicle and the securing device faces a surface on which the vehicle is supported, and in the translated position, at least a portion of the mounting platform extends beyond the rear end of the vehicle and the securing device faces away from the surface on which the vehicle is supported.

In some implementations, a motorized bicycle rack is configured to be coupled to a roof of a vehicle. The motorized bicycle rack includes a base rail configured to be rigidly coupled to the roof of the vehicle and a mounting platform coupled to the base rail. The mounting platform defines a rotational axis that is oriented parallel to a longitudinal axis of the vehicle. The mounting platform has a securing device configured to selectively couple a bicycle to the mounting platform. The motorized bicycle rack further includes a translational actuator operably coupled to the mounting platform. The translational actuator is configured to move the mounting platform along the longitudinal axis of the vehicle. The motorized bicycle rack further includes a rotational actuator operably coupled to the mounting platform. The rotational actuator is configured to rotate the mounting platform relative to the base rail about the rotational axis. The translational actuator is configured to move the mounting platform between a stored position and a translated position. The rotational actuator is configured to rotate the mounting platform between a loading position and the translated position. In the loading position, the mounting platform extends beyond a rear end of the vehicle and the securing device faces a surface on which the vehicle is supported, and in the translated position, the mounting platform extends beyond the rear end of the vehicle and the securing device faces away from the surface on which the vehicle is supported.

### BRIEF DESCRIPTION OF DRAWINGS

Various implementations of devices, systems, and methods are explained in even greater detail in the following drawings. The drawings are merely exemplary and certain features may be used singularly or in combination with other features. The drawings are not necessarily drawn to scale.

FIG. 1A is a schematic view of a motorized bicycle rack according to an implementation of the disclosure.

FIG. 1B is a schematic view of a motorized bicycle rack according to another implementation of the disclosure.

FIG. 2 is a side view of a vehicle with the motorized bicycle rack of FIGS. 1A or 1B coupled to a roof of the vehicle and illustrating a mounting platform in a stored position relative to a base rail.

FIG. 3 is a side view of the vehicle illustrating the mounting platform of the motorized bicycle rack of FIGS. 1A or 1B in a translated position relative to the base rail.

FIG. 4 is a side view of the vehicle illustrating the mounting platform of the motorized bicycle rack of FIGS. 1A or 1B in a loading position relative to the base rail.

FIG. 5 is a side view of the vehicle illustrating a bicycle coupled to the mounting platform of the motorized bicycle rack of FIGS. 1A or 1B when the mounting platform is in the loading position relative to the base rail.

FIG. 6 is a side view of the vehicle illustrating the bicycle coupled to the mounting platform of the motorized bicycle rack of FIGS. 1A or 1B when the mounting platform is in the translated position relative to the base rail.

FIG. 7 is a side view of the vehicle illustrating the bicycle coupled to the motorized bicycle rack of FIGS. 1A or 1B in the stored position relative to the base rail.

FIG. 8A is an exploded schematic view of a motorized bicycle rack according to another implementation of the disclosure.

FIG. 8B is an exploded schematic view of a motorized bicycle rack according to another implementation of the disclosure.

FIG. 9 is a rear view of the vehicle illustrating the motorized bicycle rack of FIGS. 8A or 8B.

FIG. 10 is a side view of a vehicle with the motorized bicycle rack of FIGS. 8A or 8B coupled to a roof of the vehicle and illustrating a mounting platform in a stored position relative to a base rail.

FIG. 11 is a side view of the vehicle illustrating the mounting platform of the motorized bicycle rack of FIGS. 8A or 8B in a translated position relative to the base rail.

FIG. 12 is a side view of the vehicle illustrating the mounting platform of the motorized bicycle rack of FIGS. 8A or 8B in a loading position relative to the base rail and a bicycle coupled to the mounting platform.

FIG. 13 is a rear view of the vehicle illustrating the motorized bicycle rack of FIGS. 8A or 8B in the loading position relative to the mounting platform and the bicycle coupled to the bicycle rack.

FIG. 14 is a rear view of the vehicle illustrating the mounting platform of the motorized bicycle rack of FIGS. 8A or 8B in the translated position relative to the base rail and the bicycle coupled to the bicycle rack.

FIG. 15 is a side view of the vehicle illustrating the motorized bicycle rack of FIGS. 8A or 8B in the stored position relative to the base rail and the bicycle coupled to the bicycle rack.

### DETAILED DESCRIPTION

The devices, systems, and methods disclosed herein are directed towards a motorized bicycle rack coupled to a roof of a vehicle. In some implementations, the bicycle rack may be decoupled from the vehicle and stored when not in use. The figures illustrate exemplary implementations in detail and the present disclosure is not limited to the details or methodology set forth in the description or illustrated in the figures. The terminology used herein is for the purpose of description only and should not be regarded as limiting.

As used herein the term “vehicle” may encompass a passenger vehicle, a delivery vehicle, or the like for use by humans or a self-driving vehicle. In some implements, the vehicle may be a “battery electric vehicle” that is powered entirely by a battery system including battery cells. In other words, no fossil fuels are utilized, no internal combustion engine is present in the vehicle, and no alternative forms of propulsion is provided (e.g., hydrogen fuel cells, etc.). In some implementations, features of this disclosure can be used with hybrid vehicles, such as plug-in hybrid vehicles, hybrid vehicles (e.g., full hybrid vehicles), mild hybrid electric vehicles, and range extended hybrid vehicles.

Referring to the figures generally, the various implementations disclosed herein relate to systems, apparatuses, and methods for a motorized bicycle rack. The motorized bicycle rack provides access to the bicycle rack without having to lift the bicycle above the roof of the vehicle or interfering with a liftgate of the vehicle. In particular, a bike mounted near the liftgate could interfere with advanced driver-assistance system (ADAS) features. For example, radar sensors and ultrasonic sensors are unable to ignore the bicycle, which causes ADAS features to be unavailable or cause false braking events. As such, the bicycle rack provides advantages for vehicles with taller roofs (e.g., SUVs or the like), so the operator does not have to reach above the vehicle.

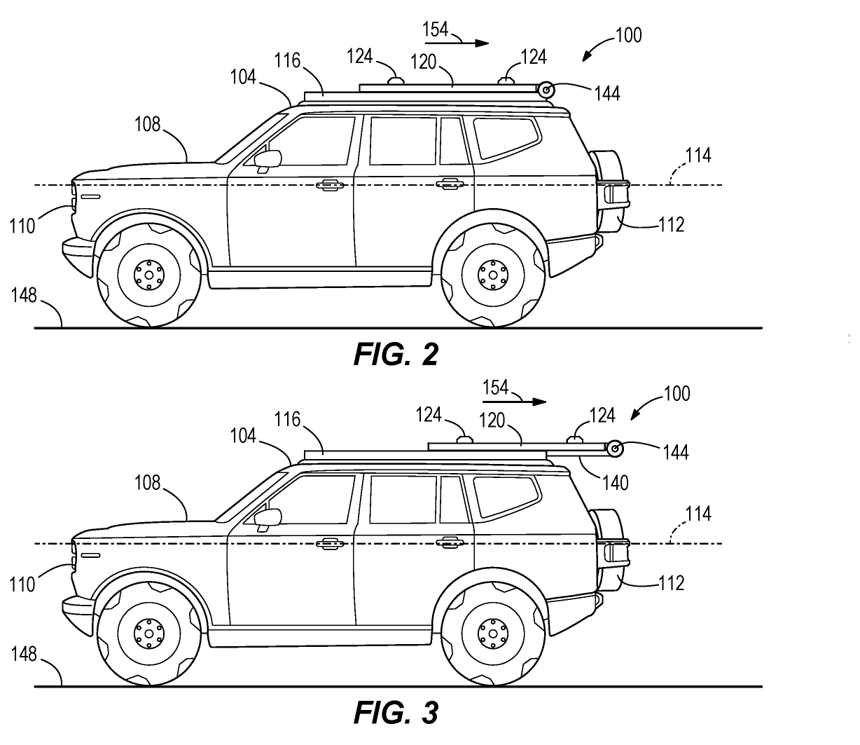

Now with reference to FIG. 2, a motorized bicycle rack 100 according to an implementation of the disclosure is illustrated. The motorized bicycle rack 100 may be coupled to a roof 104 of a vehicle 108. The vehicle 108 includes a front end 110, a rear end 112, and a longitudinal axis 114 extending between the front and rear ends 110, 112. The rack 100 is coupled to the roof 104 and extends along the longitudinal axis 114. In the illustrated implementation, the motorized bicycle rack 100 extends partially between the front and rear end 110, 112 of the vehicle 108. It should be appreciated that FIGS. 2-7 apply equally to the motorized bicycle rack 100a and the bicycle rack 100b, which are described in detail below.

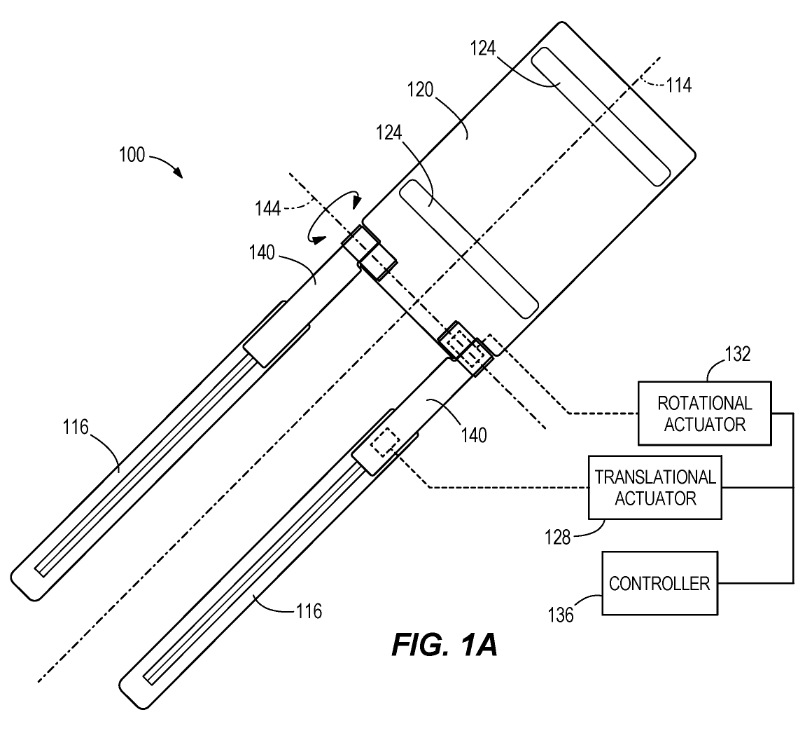

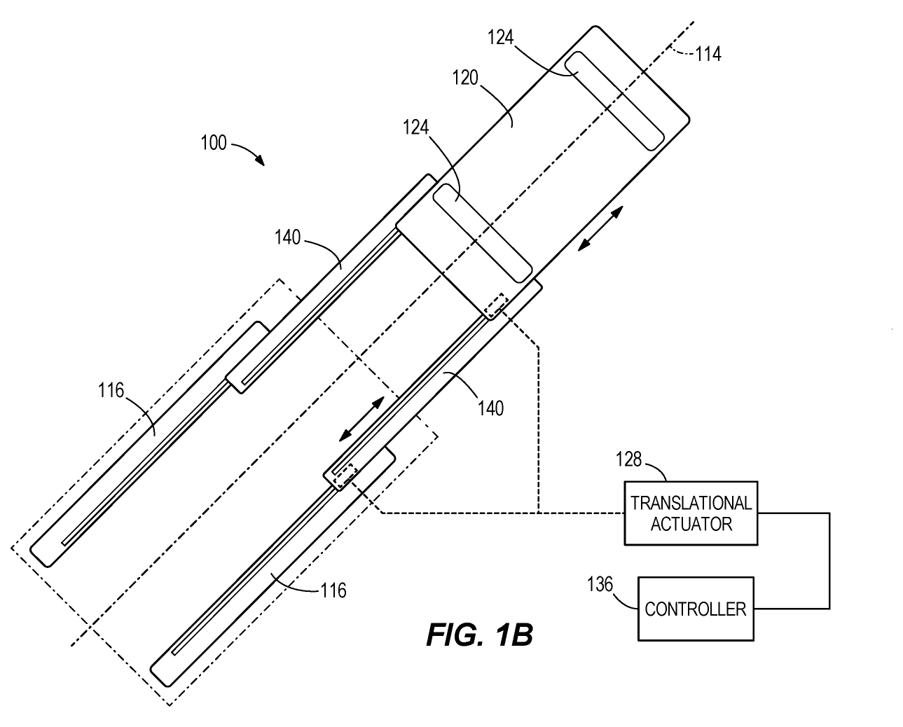

Now with reference to FIGS. 1A and 1B, the rack 100a, 100b includes one or more base rail(s) 116 that are rigidly coupled to the roof 104 of the vehicle 108 and a mounting platform 120 coupled to the base rail(s) 116. The mounting platform 120 includes one or more securing device(s) 124 that selectively secures a bicycle 126 (FIGS. 5-7) to the mounting platform 120. The one or more securing devices(s) 124 may selectively secure more than one bicycle 126 to the mounting platform 120. For example, the mounting platform 120 may allow for multiple bicycles (two, three, etc.) to be mounted side by side (e.g., in a direction orthogonal to the axis 114).

The bicycle rack 100a, 100b further includes a translational actuator 128 and a rotational actuator 132, which are each operably coupled to the mounting platform 120 to move the mounting platform 120 relative to the base rail(s) 116. A controller 136 is operably coupled to the translational actuator 128 and the rotational actuator 132 to selectively activate the actuators 128, 132 to adjust a position of the mounting platform 120.

The base rail(s) 116 may be directly coupled to the roof of the vehicle 108. In other implementations, the base rail(s) 116 may be coupled to the vehicle 108 through an existing roof rail of the vehicle 108. Further, in the illustrated implementation, the rack 100a, 100b includes a pair of base rails 116, which are spaced apart from each other on the roof 104 of the vehicle 108 (e.g., in a direction orthogonal to the longitudinal axis 114). In other implementations, the bicycle rack 100 may include more (e.g., three, four, etc.) or fewer (e.g., one) base rail(s) 116.

In the implementation of the bicycle rack 100a shown in FIG. 1A, the bicycle rack 100a include a translational portion 140a coupled between the mounting platform 120 and the base rail(s) 116. The translational portion 140a is movable relative to the base rail(s) 116 to allow translational movement of the mounting platform 120 along the longitudinal axis 114 (FIG. 2). For example, the translational portion 140a may be an extension rail that is movable relative to the base rail(s) 116. In the illustrated implementation, the translational portion 140a is a telescoping linear actuator that allows the mounting platform 120 to move relative to the base rail(s) 116.

In the implementation shown in FIG. 1B, the translational portion 140b is slidably coupled to the base rail(s) 116. In the illustrated implementation, the translational portion(s) 140b are coupled to an inner surface of the base rail(s) 116 and are coupled to an outer surface of the mounting platform 120. In other implementations, the translational portion 140b may be slidably coupled to the mounting platform 120. It should be appreciated that the difference between the bicycle rack 100a and the bicycle rack 100b is the configuration of the translational portion(s) 140a, 140b. As such, the remaining description referring to the bicycle rack 100 applies equally to the bicycle rack 100a and the bicycle rack 100b.

The securing device(s) 124 selectively or removably couples the bicycle 126 to the mounting platform 120 when the bicycle rack 100 is in the loading position (FIG. 5). It should be appreciated that “selectively” or “removably” may be used interchangeably herein. In other words, the securing device(s) 124 may be selectively coupled to the bicycle 126 to allow the bicycle 126 to be coupled to the mounting platform 120 or uncoupled from the bicycle 126 to allow the bicycle 126 to be removed from the mounting platform 120. Therefore, the bicycle 126 is removably coupled to the mounting platform 120 via the securing device(s) 124.

The securing device(s) 124 may be any mechanism that couples the bicycle 126 to the mounting platform 120, such as a bracket, hook, clip, strap, or similar coupling device, and/or any combination thereof. In the illustrated implementation, the mounting platform includes a pair of securing devices 124, which are spaced apart along the longitudinal axis 114 to selectively secure separate portions of the bicycle 126. For example, each securing device 124 may include a hook that engages with a tire of the bicycle 126 (e.g., a front tire and a rear tire) and a strap that secures the frame of the bicycle 126 to the mounting platform 120. In other embodiments, one of the securing devices 124 may be configured to engage with a front fork of the bicycle 126. For example, the front tire of the bicycle 126 may be removed and the securing device 124 may be coupled directly to the front fork while the front tire is secured within the vehicle 108. The mounting platform 120 may include multiple securing devices 124, such that each securing device 124 or pair of securing devices 124 couples one of a plurality of bicycles 126 to the mounting platform 120.

With continued reference to FIGS. 1A and 1B, the mounting platform 120 extends along or between the pair of base rails 116 in a direction orthogonal to the longitudinal axis 114. In some implementations, the mounting platform 120 may be a unitary structure (e.g., formed of a single piece of material), while in other implementations the mounting platform 120 may be comprised of multiple components, such as multiple rails that extend along and from the base rails 116. The mounting platform 120 is configured to rotate about a rotational axis 144. The rotational axis 144 is oriented orthogonally to the longitudinal axis 114 and parallel to a surface 148 (FIG. 2) on which the vehicle 108 is supported. In some implementations, the rotational axis 144 is perpendicular to the longitudinal axis 114.

The translational actuator 128 moves the mounting platform 120 along the longitudinal axis 114 of the vehicle 108 relative to the base rail(s) 116 and the roof 104 of the vehicle 108. The translational actuator 128 may be a linear drive motor coupled to a linear ball bearing slide. In such an implementation, the controller 136 may activate the linear drive motor to move the mounting platform 120 along the longitudinal axis 114 via the linear ball bearing slide. In other implementations, the translational actuator 128 may be a screw mechanism, a wheel and axle mechanism, a cam mechanism, a telescoping mechanism, or the like. The translational actuator 128 may further include a locking device that restricts movement of the mounting platform 120 when the platform is in a stored position (FIG. 2). For example, the translational actuator 128 may be a self-locking actuator. In other implementations, the locking device may be a separate component that engages the mounting platform 120 to restrict movement of the mounting platform 120 or that engages the translational portion 140 to restrict movement of the translational portion 140.

The rotational actuator 132 rotates the mounting platform 120 relative to the base rail 116 about the rotational axis 144. In some implementations, the rotational actuator 132 is a servo motor that adjusts an angular position of the mounting platform 120. The controller 136 may activate the servo motor to move the mounting platform 120 about the rotational axis 144. In other implementations, the rotational actuator 132 may be an electric motor combined with an additional sensor that detects the position of the mounting platform. In some implementations, the rotational actuator 132 may be directly coupled to the computing system or controller of the vehicle.

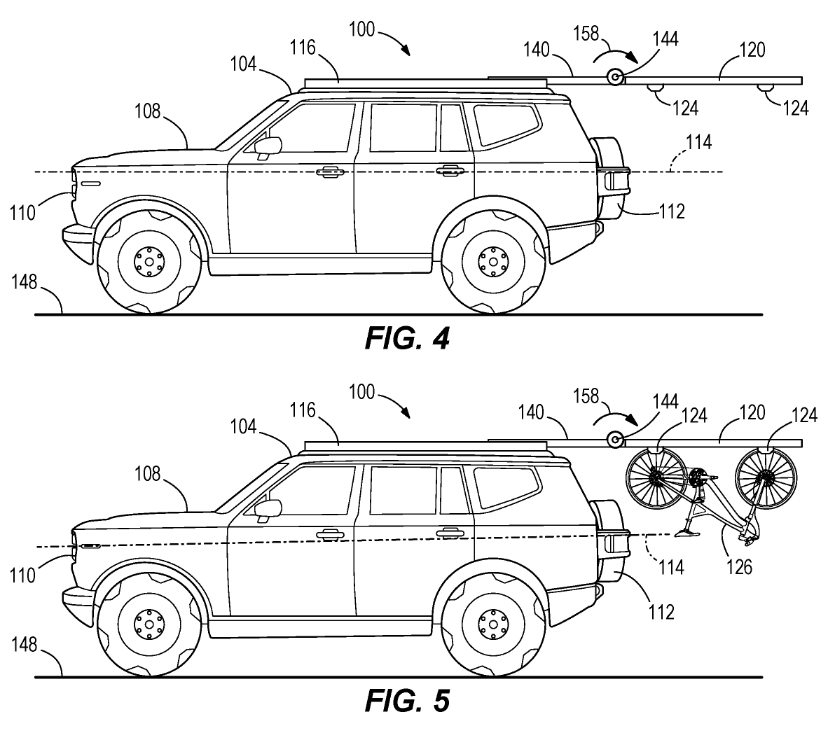

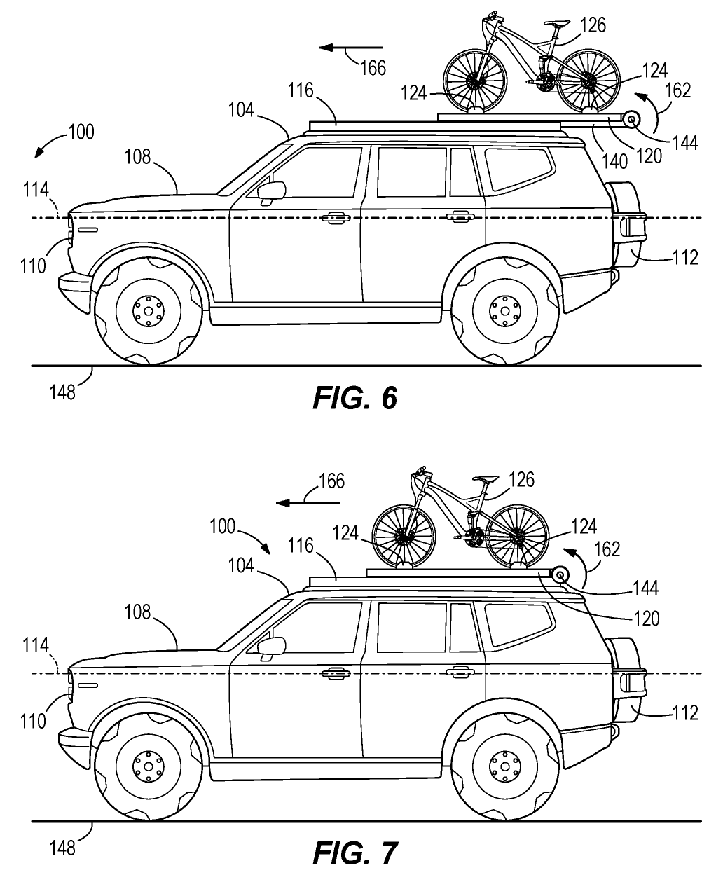

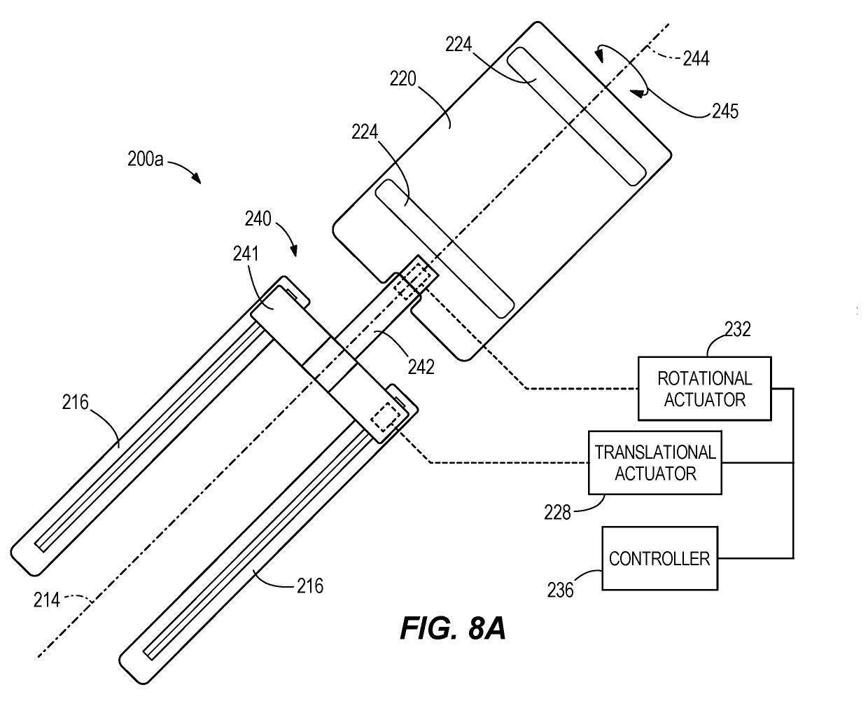

Now with reference to FIGS. 2-7, movement of the mounting platform 120 of the bicycle rack 100 between a stored position (FIGS. 2 and 7), a translated position (FIGS. 3 and 6), and a loading position (FIGS. 4 and 5) are illustrated. The construction of the bicycle rack 100 allows the operator to secure the bicycle without having to lift the bicycle 126 above the roof 104 of the vehicle 108. Additionally, the bicycle rack 100 avoids blocking sensors on the vehicle 108 (e.g., sensors on a rear end 112 or roof 104 of the vehicle 108). Furthermore, the bicycle rack 100 reduces the need for an operator to reach above the roof 104 of the vehicle 108, which improves the efficiency and ease of mounting a bicycle on tall vehicles (SUVs or the like).

In some implementations, the operator may provide a first input to the controller 136 to initiate movement of the mounting platform 120 from the stored position (FIG. 2) to the translated position (FIG. 3) and a second input to initiate movement of the mounting platform 120 from the translated position to the loading position (FIG. 4) to allow the bicycle to be coupled to the mounting platform 120 (FIG. 5). Once the bicycle 126 is coupled to the mounting platform 120, the operator may provide a third input to the controller 136 to initiate movement of the mounting platform 120 from the loading position (FIG. 5) to the translated position (FIG. 6) and a fourth input to move the mounting platform 120 from translated position to the stored position (FIG. 7).

It should be appreciated that inputs from the user may be provided via a remote controller in communication with the controller 136, a switch on the bicycle rack 100, a switch within the vehicle, an interface within the vehicle such as the infotainment interface, or the like. In addition, it should be appreciated that a single user input from the operator may sequentially provide the first and second inputs to the controller 136, which would move the mounting platform 120 from the stored position to the loading position. Additionally, a single user input from the operator may sequentially provide the third and fourth inputs to the controller 136 to move the mounting platform 120 from the loading position to the stored position.

FIG. 2 illustrates the bicycle rack 100 in the stored position without the bicycle 126 coupled to the mounting platform 120. In the stored position, the securing device(s) 124 faces away from the surface 148 that the vehicle 108 is supported on. In some implementations, the translational actuator 128 and/or a separate locking device may be used to secure mounting platform 120 in the stored position when operating the vehicle 108.

FIG. 3 illustrates the mounting platform 120 in the translated position. The controller 136 receives the first input, which activates the translational actuator 128 to move the mounting platform 120 in a first translational direction 154 until a portion of the mounting platform 120 extends beyond the rear end 112 of the vehicle 108. In the illustrated implementation, the mounting platform is moved until the rotational axis 144 is positioned beyond the rear end 112 of the vehicle 108. Further, a portion of the mounting platform 120 is still positioned over the base rail(s) 116 and the roof 104 in the translated position. The securing device(s) 124 also faces away from the surface 148 on which the vehicle 108 is supported in the translated position.

FIG. 4 illustrates the mounting platform 120 in the loading position without the bicycle 126 coupled to the mounting platform 120. The controller 136 receives the second input, which activates the rotational actuator 132 to rotate the mounting platform 120 about the rotational axis 144 relative to the base rail(s) 116 to move the mounting platform 120 from the translated position to the loading position. The mounting platform 120 rotates in a first rotational direction 158 about the rotational axis such that the mounting platform 120 extends beyond the rear end 112 of the vehicle 108 and securing device(s) 124 of mounting platform 120 faces the surface 148 that the vehicle 108 is supported on. In the illustrated implementation, the rotational actuator 132 rotates the mounting platform 120 180 degrees in the first rotational direction 158 relative to the base rail(s) 116 when moving the mounting platform 120 from the translated position to the loading position. In other implementations, the mounting platform 120 may be rotated in a range from 150 degrees to 210 degrees.

FIG. 5 illustrates the mounting platform 120 in the loading position with the bicycle 126 coupled to the mounting platform 120. To load and secure the bicycle 126 to the mounting platform 120, the tires and/or fork of the bicycle 126 are coupled to the securing device(s) 124, as described above. Once the bicycle 126 is coupled to the mounting platform 120, the controller 136 receives the third and fourth inputs to initiate movement of the mounting platform 120 from the loading position (FIG. 5) to the translated position (FIG. 6) and to the stored position (FIG. 7).

FIG. 6 illustrates the mounting platform 120 in the translated position with the bicycle coupled to the mounting platform. The controller 136 receives the third input, which activates the rotational actuator 132 to rotate the mounting platform 120 about the rotational axis 144 relative to the base rail(s) 116 to move the mounting platform 120 from the loading position to the translated position. The mounting platform 120 rotates in a second rotational direction 162 about the rotational axis 144 such that the mounting platform 120 returns to the translated position (e.g., similar to FIG. 3, described above). In the illustrated implementation, the rotational actuator 132 rotates the mounting platform 120 180 degrees in the second rotational direction 162 relative to the base rail(s) 116 when moving the mounting platform from the translated position to the loading position. In other implementations, the mounting platform 120 may be rotated in a range from 150 degrees to 210 degrees.

FIG. 7 illustrates the bicycle rack 100 in the stored position with the bicycle 126 coupled to the mounting platform 120. The controller 136 receives the fourth input, which activates the translational actuator 128 to move the mounting platform 120 in a second translational direction 166 until the mounting platform 120 returns to the stored position (similar to FIG. 2, described above). In some implementations, the translational actuator 128 and/or a separate locking device may be used to secure mounting platform 120 in the stored position when operating the vehicle 108.

In some implementations, the bicycle rack 100 may be devoid of the translational portion 140 and transitional actuator 128. In such an implementation, the rotational axis 144 may be positioned near the end 112 of the vehicle 108 (e.g., FIG. 2). The mounting platform 120 may be rotated in the first rotational direction 158 about the rotational axis 144 from the stored position (FIG. 2) to the loading position (FIG. 4) where the mounting platform 120 extends beyond the rear end 112 of the vehicle 108. In such an implementation, the mounting platform 120 may have a greater length than the mounting platform 120 illustrated in FIGS. 2-7 so there is enough clearance between the securing device(s) 124 and the end of vehicle for the bicycle(s) 126 to be coupled to the mounting platform 120. In such an implementation, the controller 136 may receive an input, which activates the rotational actuator 132 to rotate the mounting platform 120 about the rotational axis 144 relative to the base rail(s) 116 to move the mounting platform 120 from a stored position to a loading position. The mounting platform 120 rotates in a first rotational direction 158 about the rotational axis 144 such that securing device(s) 124 of the mounting platform 120 faces the surface 148 that the vehicle 108 is supported on. To load and secure the bicycle 126 to the mounting platform 120, the tires and/or fork of the bicycle 126 are coupled to the securing device(s) 124, as described above. Once the bicycle 126 is coupled to the mounting platform 120, the controller 136 receives a second input, which activates the rotational actuator 132 to rotate the mounting platform 120 about the rotational axis 144 relative to the base rail(s) 116 in the second rotational direction to move the mounting platform 120 from the loading position (FIG. 5) to the stored position (FIG. 7).

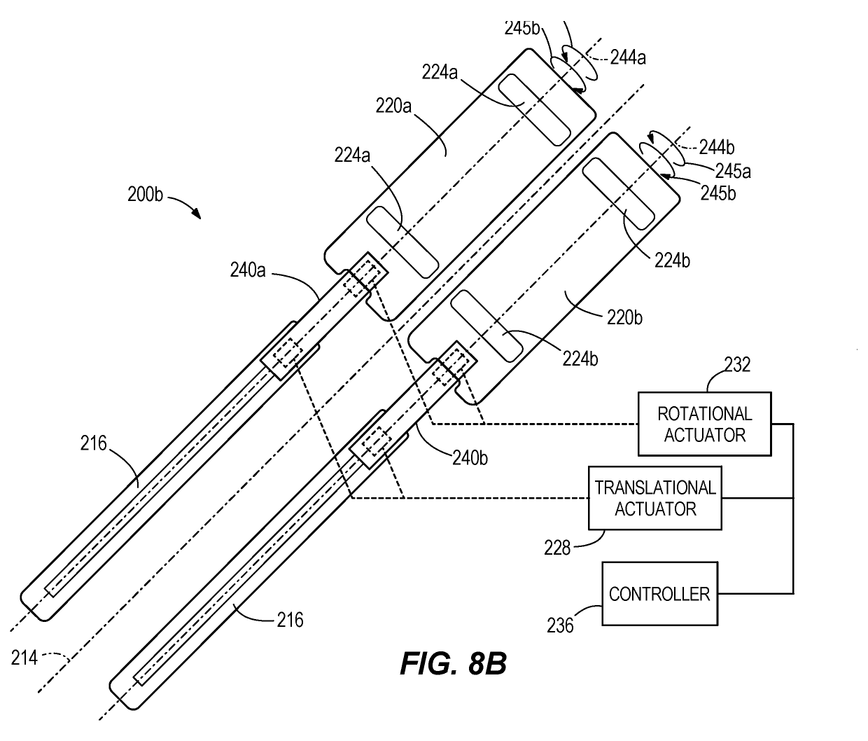

FIGS. 8A and 8B illustrate a motorized bicycle rack 200a, 200b according to alternative implementations. The bicycle racks 200a, 200b are similar to the bicycle rack 100a, 100b described above with reference to FIGS. 1-3, except as noted, and the following description focuses primarily on differences between the bicycle racks 200a, 200b and the bicycle rack 100a, 100b. In addition, common features and elements of the bicycle racks 200a, 200b corresponding with features and elements of the bicycle rack 100a, 100b are given common reference numbers plus 100.

In contrast to the bicycle rack 100 that rotates about the rotational axis 144, which is orthogonal to the longitudinal axis 114, the bicycle racks 200a, 200b rotates about a rotational axis 244 (FIG. 8A) or rotational axis 244a, 244b (FIG. 8B) that are parallel with a longitudinal axis 214. In the implementation of the bicycle rack 200a illustrated in FIG. 8A, the rotational axis 244 is colinear with the longitudinal axis 214. The bicycle rack 200a includes one or more base rail(s) 216 that are rigidly coupled to the roof of the vehicle and a mounting platform 220 coupled to the base rail(s) 216 via a translational portion 240 having a support structure 241 that extends between the two base rails 216 and a pole portion 242 extending from the support structure 241 along the longitudinal axis 214. The translational portion 240 may be movable relative to the base rail(s) 216 to allow translational movement of the mounting platform 220 along the longitudinal axis 214. For example, the support structure 241 may be movable relative to the base rail(s) 216 via a translational actuator 228. Further, the pole portion 242 is coupled to the mounting platform 220 such that the mounting platform 220 rotates about the rotational axis 244 in a rotational direction 245. For example, the rotational direction 245 may be clockwise or counterclockwise.

In the implementation of the bicycle rack 200b illustrated in FIG. 8B, the mounting platform 220 includes a first mounting platform portion 220a and a second mounting platform portion 220b, which are respectively coupled to the base rails 216 via the translational portions 240a, 240b. The translational portions 240a, 240b may be independently movable relative to the base rails 216 to allow translational movement of each of the mounting platform portions 220a, 220b along the longitudinal axis 214. In this way, the controller 236 may be configured to operate each of the translational portions 240a, 240b independently to facilitate mounting a single bicycle, or to operate the translational portions 240a, 240b together to facilitate mounting multiple bicycles. Further, the translational portions 240a, 240b are coupled to the mounting platform portions 220a, 220b such that each mounting platform portion 220a, 220b rotates about a respective rotational axis 244a, 244b. In the illustrated implementation, the rotational axis 244a, 244b of each mounting platform portion 220a, 22b is parallel to the longitudinal axis 214, but offset the longitudinal axis (e.g., closer to a right or left side of the vehicle 108). Further, each mounting platform portion 220a, 220b includes securing portions 224a, 224b coupled thereto.

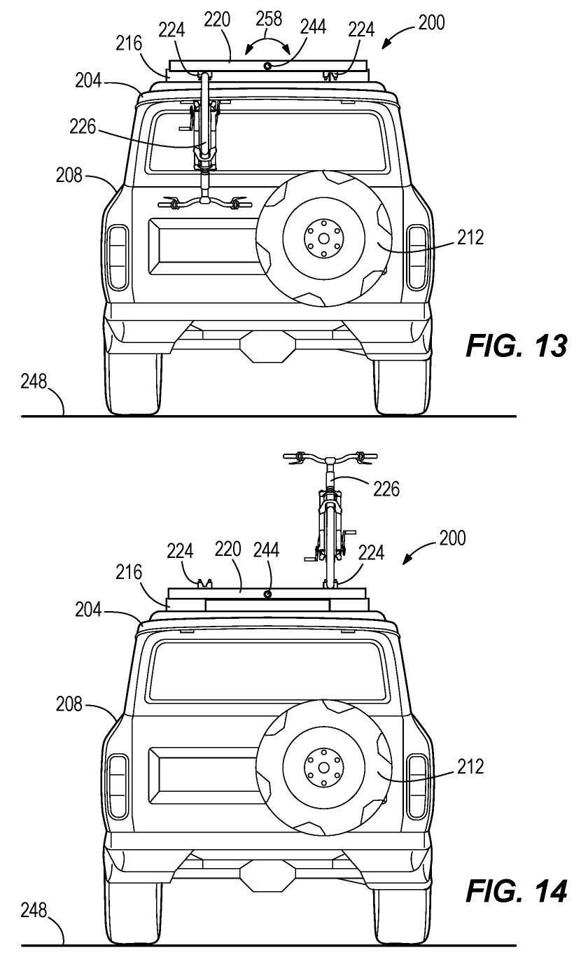

During rotation of the mounting platform portion 220a, 220b towards a loading position (FIGS. 12 and 13, described below), the first mounting platform portion 220a rotates in a first rotational direction 245a about a first rotational axis 244a and the second mounting platform portion 220b rotates in a second rotational direction 245b about a second rotational axis 244b. In the illustrated implementation, the first rotational direction 245a is counterclockwise and the second rotational direction 245b is clockwise. When a bicycle 226 is coupled to each mounting platform portion 220a, 220b and the mounting platforms are rotated towards the stored position (e.g., FIG. 13 to FIG. 14 described below), the first mounting platform portion 220a rotates in the second rotational direction 245b about the first rotational axis 244a and the second mounting platform portion 220b rotates in the first rotational direction 245b about a second rotational axis 244b. In other words, the first and second mounting platform portions 220a, 220b each rotate in an outward direction to prevent interference between the first and second mounting platform portions 220a, 220b or the bicycle(s) coupled thereto.

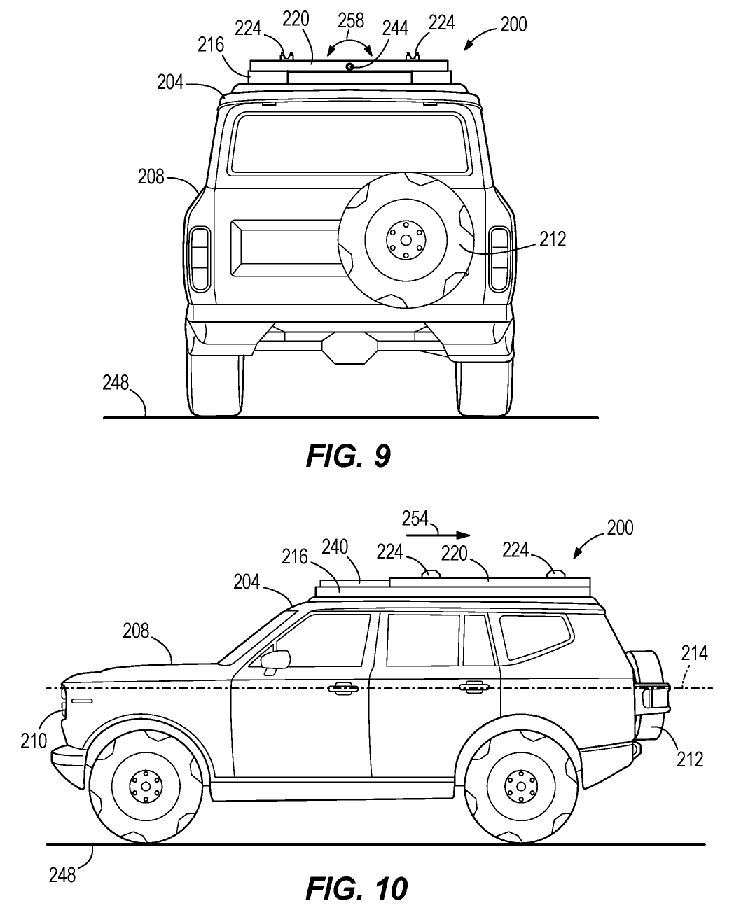

Therefore, it should be appreciated that the remainder of the bicycle rack 200a, 200b are similar to the bicycle rack 100, and for the sake of brevity will not be described in detail. Furthermore, for the sake of brevity, the movement of the bicycle racks 200a, 200b are generally described and illustrated together as the bicycle rack 200 in FIGS. 9-15.

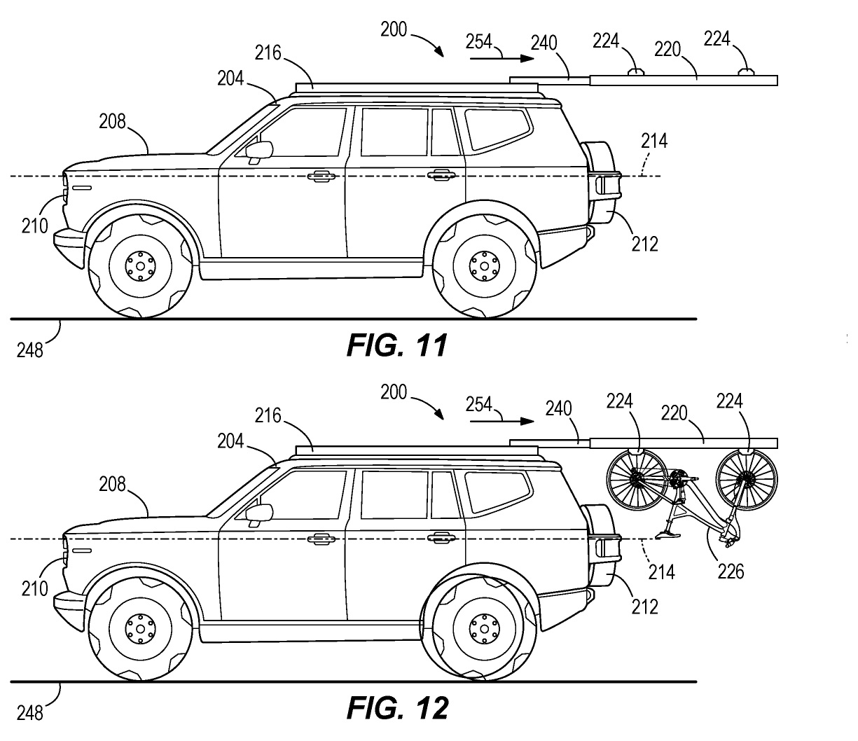

Now with reference to FIGS. 9-15, movement of the bicycle rack 200 between a stored position (FIGS. 9, 10, and 15), a translated position (FIGS. 11 and 14), and a loading position (FIGS. 12 and 13) are illustrated. The construction of the bicycle rack 200 allows the operator to secure the bicycle without having to lift the bicycle 226 above the roof 204 of the vehicle 208. Additionally, the bicycle rack 200 avoids blocking sensors on the vehicle 208 (e.g., sensors on a rear end 212 or roof 204 of the vehicle 208).

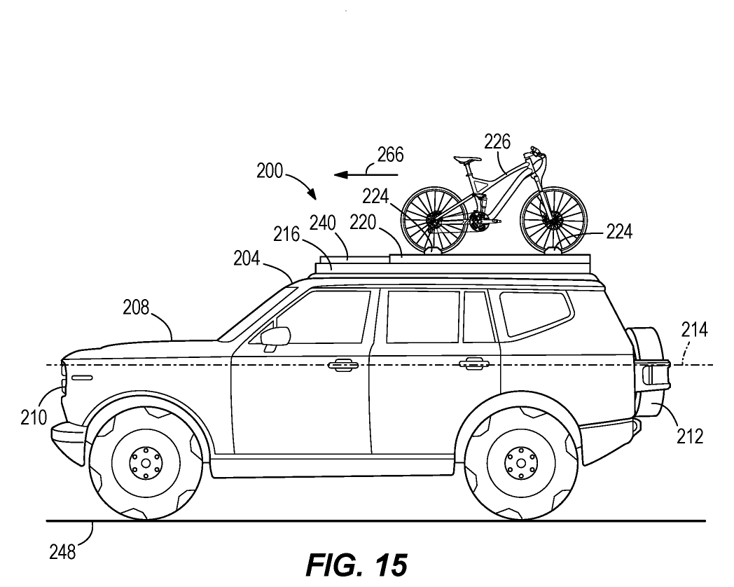

In some implementations, the operator may provide a first input to the controller 236 to initiate movement of the mounting platform 220 from the stored position (FIG. 10) to the translated position (FIG. 11) and a second input to initiate movement of the mounting platform 220 from the translated position to the loading position (FIGS. 12), where one or more securing device(s) 224 face the surface 248 the vehicle 208 is supported on to allow one or more bicycle(s) 226 to be coupled to the mounting platform 120 (FIGS. 12 and 13). Once the bicycle(s) 226 are coupled to the mounting platform 220, the operator may provide a third input to the controller 236 to initiate movement of the mounting platform 220 from the loading position (FIGS. 12 and 13) to the translated position (e.g., FIG. 6 or 14) and a fourth input to move the mounting platform 220 from translated position to the stored position (FIG. 15).

In some implementations, the securing device(s) 224 of the bicycle rack 200 may face the surface 248 the vehicle 208 is supported on when the mounting platform 220 is in the stored position (FIG. 10). In such an implementation, the operator may provide a first input to the controller 236 to initiate movement of the mounting platform 220 from the stored position (FIG. 10) to the loading position (FIGS. 12) to allow the bicycle(s) 226 to be coupled to the mounting platform 120 (FIGS. 12 and 13). Once the bicycle 226 is coupled to the mounting platform 220, the operator may provide a second input to the controller 236 to initiate movement of the mounting platform 220 from the loading position (FIGS. 12 and 13) to the translated position (e.g., FIG. 6 or 14) and a third input to move the mounting platform 220 from translated position to the stored position (FIG. 15). In other words, the bicycle rack 200 only rotates a single time during installation of the bicycle(s) 226. In some implementations, the bicycle rack 200 may have a sensor that detects whether the bicycle(s) 226 are coupled to the bicycle rack 200 to ensure that the rack 200 does not return to the stored position (e.g., where the securing device(s) 224 face the surface 248) when the bicycle 226 is coupled to the rack 200.

It should be appreciated that inputs from the user may be provided via a remote controller in communication with the controller 236, a switch on the bicycle rack 200, a switch within the vehicle, an interface within the vehicle such as the infotainment interface, or the like. In addition, it should be appreciated that a single user input from the operator may sequentially provide the first and second inputs to the controller 136 to move the mounting platform 120 from the stored position to the loading position. Additionally, a single user input from the operator may sequentially provide the third and fourth inputs to the controller 136 to move the mounting platform 120 from the loading position to the stored position.

FIGS. 9 and 10 illustrate the bicycle rack 200 in the stored position without the bicycle 226 coupled to the mounting platform 220. In the stored position, the securing device(s) 224 faces away from the surface 248 that the vehicle 208 is supported on. In some implementations, the translational actuator 228 and/or a separate locking device may be used to secure mounting platform 220 in the stored position when operating the vehicle 208.

FIG. 11 illustrates the mounting platform 220 in the translated position. The controller 236 activates the translational actuator 228 to move the mounting platform 220 in a first translational direction 254 until a portion of the mounting platform 220 extends beyond the rear end 212 of the vehicle 208. In the illustrated implementation, the mounting platform 220 is moved such that a majority of the mounting platform 220 extends beyond the rear end 212 of the vehicle 208. In particular, the securing device(s) are beyond the rear end of the vehicle 208 in the translated position. The securing device(s) 224 also face away from the surface 248 on which the vehicle 208 is supported in the translated position.

FIGS. 12 and 13 illustrate the mounting platform 220 in the loading position with the bicycle 226 coupled to the mounting platform 220. The controller 236 activates the rotational actuator 232 to rotate the mounting platform 220 about the rotational axis 244 relative to the base rail(s) 216 to move the mounting platform 220 from the translated position to the loading position. The mounting platform 220 rotates in a rotational direction 258 about the rotational axis 244 such that the mounting platform 220 extends beyond the rear end 212 of the vehicle 208 and securing device(s) 224 of mounting platform 220 faces the surface 248 that the vehicle 208 is supported on. In the illustrated implementation, the rotational actuator 232 rotates the mounting platform 220 180 degrees relative to the base rail(s) 216 when moving the mounting platform 220 from the translated position to the loading position. Further, it should be appreciated that the mounting platform 220 may be rotated in a clockwise or counterclockwise direction.

FIGS. 14 and 15 illustrate the mounting platform 220 in the translated position (FIG. 14) and the stored position (FIG. 15) with the bicycle coupled to the mounting platform 220. The controller 236 activates the rotational actuator 232 to rotate the mounting platform 220 about the rotational axis 244 relative to the base rail(s) 216 to move the mounting platform 220 from the loading position to the translated position (FIG. 14). The mounting platform 220 rotates in the rotational direction 258 about the rotational axis 244 such that the mounting platform 220 returns to the translated position (e.g., similar to FIG. 11, described above). In the illustrated implementation, the rotational actuator 232 rotates the mounting platform 220 180 degrees in the rotational direction 258 relative to the base rail(s) 216 when moving the mounting platform from the translated position to the loading position. Further, it should be appreciated that the mounting platform 220 may be rotated in a clockwise or counterclockwise direction. The controller 236 then activates the translational actuator 228 to move the mounting platform 220 in a second translational direction 266 until the mounting platform 220 returns to the stored position (FIG. 15). In some implementations, the translational actuator 228 and/or a separate locking device may be used to secure mounting platform 220 in the stored position when operating the vehicle 208. In the stored position, the bicycle 226 may be facing the rear of the vehicle 200 as depicted in FIG. 15 or facing the front of the vehicle 200 as depicted with the vehicle 100 and bicycle 126 in FIG. 7.

For purposes of this description, certain advantages and novel features of the aspects and configurations of this disclosure are described herein. In particular, the disclosed implementations of the bicycle racks 100a, 100b, 200a, 200b provide many advantages compared to bicycle racks of the prior art. For example, the disclosed bicycle racks do not use a hitch mount, which could prevent opening a liftgate or tailgate of the vehicle, restrict access to a spare wheel coupled to the rear end of the vehicle, or block ADAS sensors or cameras on the rear end of the vehicle. Additionally, the disclosed bicycle racks 100a, 100b, 200a, 200b do not add additional materials or structures, in particular additional metal, near existing ADAS cameras and/or sensors, which reduces the likelihood for false alerts or braking events from the ADAS system of the vehicle. Further, the bicycle racks 100a, 100b, 200a, 200b do not require people to reach on top of the vehicle. For example, if the vehicle is tall and/or the operator is short, the disclosed bicycle rack allows the operator to load the bicycle with ease. Additionally, the disclosed bicycle racks 100a, 100b, 200a, 200b are stronger than trunk bike racks and reduce unnecessary damage to the vehicle (e.g., without damaging the liftgate, roof, or any other portion of the vehicle).

The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise.

The terms “coupled” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

Certain terminology is used in the following description for convenience only and is not limiting. The words “front”, “rear”, “right”, and “left”, designate direction in the drawings to which reference is made.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A motorized bicycle rack configured to be coupled to a roof of a vehicle, the motorized bicycle rack comprising:
a base rail configured to be rigidly coupled to the roof of the vehicle;
a mounting platform coupled to the base rail, the mounting platform defining a rotational axis, the mounting platform having a securing device configured to selectively couple a bicycle to the mounting platform;
a translational actuator operably coupled to the mounting platform, the translational actuator configured to move the mounting platform along a longitudinal axis of the vehicle; and
a rotational actuator operably coupled to the mounting platform, the rotational actuator configured to rotate the mounting platform relative to the base rail about the rotational axis,
wherein the translational actuator is configured to move the mounting platform between a stored position and a translated position,
wherein the rotational actuator is configured to rotate the mounting platform between a loading position and the translated position, wherein in the loading position, the mounting platform extends beyond a rear end of the vehicle and the securing device faces a surface on which the vehicle is supported, and in the translated position, at least a portion of the mounting platform extends beyond the rear end of the vehicle and the securing device faces away from the surface on which the vehicle is supported.

2. The motorized bicycle rack of claim 1, wherein the rotational axis is oriented orthogonal to the longitudinal axis and parallel to the surface on which the vehicle is supported.

3. The motorized bicycle rack of claim 2, wherein the translational actuator is configured to move the mounting platform so the rotational axis is positioned beyond the rear end of the vehicle.

4. The motorized bicycle rack of claim 2, wherein the rotational actuator rotates the mounting platform 180 degrees in a first direction relative to the base rail when moving the mounting platform from the translated position to the loading position, and wherein the rotational actuator rotates the mounting platform 180 degrees in a second direction relative to the base rail when moving the mounting platform from the loading position to the translated position, and wherein the second direction is opposite the first direction.

5. The motorized bicycle rack of claim 1, wherein the base rail is a first rail base and a second base rail is rigidly coupled to the roof of the vehicle, and wherein a translational portion is coupled between the mounting platform and the first and second base rails.

6. The motorized bicycle rack of claim 5, wherein the mounting platform includes a first mounting platform portion and a second mounting platform portion, which are respectively coupled to the first and second base rail via the translational portion, and wherein the first and second mounting platform portions are configured to rotate about a respective rotational axis that are each parallel to and offset the longitudinal axis.

7. The motorized bicycle rack of claim 5, wherein the translational portion includes a support structure that extends between the first and second base rails and a pole portion extending from the support structure along the longitudinal axis, and wherein the rotational axis is oriented parallel to the longitudinal axis.

8. The motorized bicycle rack of claim 1, further comprising a controller configured to selectively activate the translational actuator and the rotational actuator to adjust the position of the mounting platform.

9. The motorized bicycle rack of claim 8, wherein the translational actuator includes a linear ball bearing slide and a drive motor operably coupled to the linear ball bearing slide, and wherein the controller is configured to activate the drive motor to adjust the position of the linear bearing to move the mounting platform from the stored position to the translated position.

10. The motorized bicycle rack of claim 8, wherein the rotational actuator is a servo motor configured to adjust an angular position of the mounting platform about the rotational axis, and wherein the controller is configured to activate the servo motor to move the mounting platform from the translated position to the loading position.

11. A motorized bicycle rack configured to be coupled to a roof of a vehicle, the motorized bicycle rack comprising:
a base rail configured to be rigidly coupled to the roof of the vehicle;
a mounting platform coupled to the base rail, the mounting platform defining a rotational axis, the mounting platform having a securing device configured to selectively couple a bicycle to the mounting platform;
a translational actuator operably coupled to the mounting platform, the translational actuator configured to move the mounting platform along a longitudinal axis of the vehicle; and
a rotational actuator operably coupled to the mounting platform, the rotational actuator configured to rotate the mounting platform relative to the base rail about the rotational axis,
wherein the translational actuator is configured to move the mounting platform between a stored position and a translated position,
wherein the rotational actuator is configured to rotate the mounting platform between a loading position and the translated position, wherein in the loading position, the rotational axis of the mounting platform is beyond a rear end of the vehicle and the securing device faces a surface on which the vehicle is supported, and in the translated position, at least a portion of the mounting platform extends beyond the rear end of the vehicle and the securing device faces away from the surface on which the vehicle is supported.

12. The motorized bicycle rack of claim 11, wherein the rotational axis is oriented orthogonal to the longitudinal axis and parallel to the surface on which the vehicle is supported.

13. The motorized bicycle rack of claim 11, wherein the rotational actuator rotates the mounting platform 180 degrees in a first direction relative to the base rail when moving the mounting platform from the translated position to the loading position, and wherein the rotational actuator rotates the mounting platform 180 degrees in a second direction relative to the base rail when moving the mounting platform from the loading position to the translated position, and wherein the second direction is opposite the first direction.

14. The motorized bicycle rack of claim 11, wherein the base rail is a first rail base and a second base rail is rigidly coupled to the roof of the vehicle, and wherein a first translational portion is coupled between the mounting platform and the first base rail and a second translational portion is coupled between the mounting platform and the second base rail.

15. The motorized bicycle rack of claim 11, wherein the translational actuator is configured to move the mounting platform from the stored portion to the loading position where the securing device faces the surface on which the vehicle is supported, and wherein the rotational actuator rotates the mounting platform 180 degrees in a relative to the base rail to move the mounting platform from the loading position to the translated position.

16. The motorized bicycle rack of claim 11, further comprising a controller configured to selectively activate the translational actuator and the rotational actuator to adjust the position of the mounting platform.

17. A motorized bicycle rack configured to be coupled to a roof of a vehicle, the motorized bicycle rack comprising:
a base rail configured to be rigidly coupled to the roof of the vehicle;
a mounting platform coupled to the base rail, the mounting platform defining a rotational axis that is oriented parallel to a longitudinal axis of the vehicle, the mounting platform having a securing device configured to selectively couple a bicycle to the mounting platform;
a translational actuator operably coupled to the mounting platform, the translational actuator configured to move the mounting platform along the longitudinal axis of the vehicle; and
a rotational actuator operably coupled to the mounting platform, the rotational actuator configured to rotate the mounting platform relative to the base rail about the rotational axis,
wherein the translational actuator is configured to move the mounting platform between a stored position and a translated position,
wherein the rotational actuator is configured to rotate the mounting platform between a loading position and the translated position, wherein in the loading position, the mounting platform extends beyond a rear end of the vehicle and the securing device faces a surface on which the vehicle is supported, and in the translated position, the mounting platform extends beyond the rear end of the vehicle and the securing device faces away from the surface on which the vehicle is supported.

18. The motorized bicycle rack of claim 17, wherein the rotational actuator rotates the mounting platform 180 degrees in a rotational direction relative to the base rail when moving the mounting platform from the translated position to the loading position, and wherein the rotational actuator rotates the mounting platform 180 degrees in the rotational direction relative to the base rail when moving the mounting platform from the loading position to the translated position.

19. The motorized bicycle rack of claim 17, wherein
the base rail is a first rail base and a second base rail is rigidly coupled to the roof of the vehicle,
a first translational portion is coupled between the mounting platform and the first base rail and a second translational portion is coupled between the mounting platform and the second base rail
the mounting platform includes a first mounting platform portion and a second mounting platform portion, which are respectively coupled to the first and second base rail via the first translational portion and the second translational portion, and
the first and second mounting platform portions are configured to rotate about a respective rotational axis that are each parallel to and offset the longitudinal axis.

20. The motorized bicycle rack of claim 17, wherein
the base rail is a first rail base and a second base rail is rigidly coupled to the roof of the vehicle,
a translational portion is coupled between the mounting platform and the first and second base rail, and
the translational portion includes a support structure that extends between the first and second base rails and a pole portion extending from the support structure along the longitudinal axis.

21. The motorized bicycle rack of claim 17, further comprising a controller configured to selectively activate the translational actuator and the rotational actuator to adjust the position of the mounting platform.
